(19) United States
(12) Patent Application Publication
(10) Pub. No.: US 2003/0029074 A1
(43) Pub. Date: Feb. 13, 2003

(54) Human decoy and methods for making and using the human decoy

(76) Inventor: Joel E. Volz, Howell, MI (US)

Correspondence Address: WILLIAM J. TUCKER, 8650 SOUTHWESTERN BLVD. #2825, DALLAS, TX, 75206, US

(21) Appl. No.: 09/962,826

(22) Filed: Sep. 24, 2001

Related U.S. Application Data
(60) Provisional application No. 60/310,228, filed on Aug. 7, 2001.

(51) Int. Cl. A01M 31/06

(52) U.S. Cl. 43/2

(57) ABSTRACT

A stuffed human decoy and methods for making and using the human decoy are described. The stuffed human decoy (e.g., dummy, mannequin) is designed to be placed in a blind or tree stand and serves to take the place of a hunter so that, when the hunter is absent, the presence of the human decoy conditions wild animals (e.g., deer) to the presence of the hunter. The human decoy also serves as a trespassing tool to deter another hunter from coming too close to the hunting area of the hunter. The human decoy resembles the shape of a human and can be constructed of lightweight camouflaged weatherproof material. The human decoy can include one or more pairs of mating hooks and loop patches such as VELCRO that can be used by the hunter to fold the limbs of the human decoy which makes it easier for the hunter to transport the human decoy. Moreover, the human decoy can include one or more straps that can be used by the hunter to mount the human decoy to a tree or a blind and can also be used to stabilize the folded human decoy during transport.

### CLAIMING BENEFIT OF PRIOR FILED PROVISIONAL APPLICATION

This application claims the benefit of U.S. Provisional Application Serial No. 60/310,228 filed on Aug. 7, 2001 and entitled “HUMAN DECOY” which is incorporated by reference herein.

### BACKGROUND OF THE INVENTION

1. Field of the Invention

The present invention relates to decoys. More particularly, the present invention relates to a human-shaped decoy, dummy or mannequin for use in a blind, which acclimates game to the presence of a human.

2. Description of Related Art

Blinds for game such as deer are very useful to a hunter. The game, however, become accustomed to an empty blind, and upon occupancy by the hunter the game may not come near the blind. It would be desirable to have a human-shaped decoy that simulates a hunter in appearance, is executable in various configurations, and is easily carried by the hunter to and from the blind. Moreover, the casual sight of such a decoy would discourage other hunters from taking over the blind.

U.S. Pat. No. 5,682,701, issued Nov. 4, 1997, to Gammon describes a one or two-part dummy for use in a hunter's blind to condition game. The dummy in the '701 patent is not amenable to being placed in a squatting position, but is held upright against a tree trunk, and is inflatable. The inflatable dummy is subject to permanent damage by sharp sticks or a hunter's bullet. Moreover, it is time consuming and difficult for a hunter to inflate and deflate the dummy every time the hunter needs to use, store and transport the dummy.

U.S. Pat. No. 6,079,139 issued Jun. 27, 2000, to Berry describes an apparatus for conditioning game to the occupation of a hunting blind. A plug member in the shape of a human head is suspended in the hunting blind. The apparatus of '139 patent is effective for use in a water foul blind but not effective for use in a forest environment.

U.S. Pat. No. 5,340,350, issued Aug. 23, 1994 to Fink et al., describes a multi-positional inflatable decoy representative of at least the upper portion of the human body. The decoy of the '350 patent would not be appropriate for use in a forest environment where it could easily be punctured and rendered useless, similar to the dummy described in the '701 patent. Accordingly, there is a need for a human decoy that is designed to address the aforementioned problems and other problems associated with the traditional human decoys. This need and other needs are addressed by the human decoy and methods of the present invention.

### BRIEF DESCRIPTION OF THE INVENTION

The present invention is a stuffed human decoy (e.g., dummy, mannequin) designed to be placed in a deer blind or tree stand and serves to take the place of a hunter so that, when the hunter is absent, the presence of the human decoy conditions wild animals to the presence of the hunter. The human decoy also serves as a trespassing tool to deter another hunter from coming too close to the hunting area of the hunter. The human decoy resembles the shape of a human and can be constructed of lightweight camouflaged weatherproof material. The human decoy can include one or more pairs of mating hooks and loop patches such as VELCRO that can be used by the hunter to fold the limbs of the human decoy which makes it easier for the hunter to transport the human decoy. Moreover, the human decoy can include one or more straps that can be used by the hunter to mount the human decoy to a tree or a blind and can also be used to stabilize the folded human decoy during transport. Also described herein are methods for making and using the stuffed human decoy.

As such, it is an objective of the present invention to provide a human decoy or mannequin that can condition game to the presence of a hunter by placing it in a blind.

It is another objective of the present invention to provide a human decoy or mannequin to serve as a trespassing tool to deter other hunters from approaching the blind.

It is yet another objective of the invention to provide a human decoy or mannequin that is camouflaged according to the season.

Another objective of the present invention is to provide a human decoy or mannequin that can be folded for easy transport.

Yet another objective of the present invention is to provide a human decoy or mannequin which has matching patches to assist in the folding of the human decoy. These matching patches are releasable and reusable.

Still yet another objective of the present invention is to provide a human decoy or mannequin which is inexpensive to make, easy to handle and fully effective in accomplishing its intended purposes.

These and other objectives of the present invention will become readily apparent upon further review of the following specifications and drawings.

### BRIEF DESCRIPTION OF THE DRAWINGS

A more complete understanding of the present invention may be had by reference to the following detailed description when taken in conjunction with the accompanying drawings wherein:

FIG. 1 is a side elevated view of a human decoy seated in a deer blind according to the present invention;

FIG. 2 is a front elevated view of the human decoy in a standing position and dressed in fall camouflage;

FIG. 3 is a rear elevated view of the human decoy in a standing position and dressed in winter camouflage;

FIG. 4 is a side view of the human decoy that has been folded and strapped so it can be easily transported;

FIG. 5 is a flowchart illustrating the steps of a preferred method for using the human decoy; and

FIG. 6 is a flowchart illustrating the steps of a preferred method for making the human decoy.

### DETAILED DESCRIPTION OF THE PREFERRED EMBODIMENTS

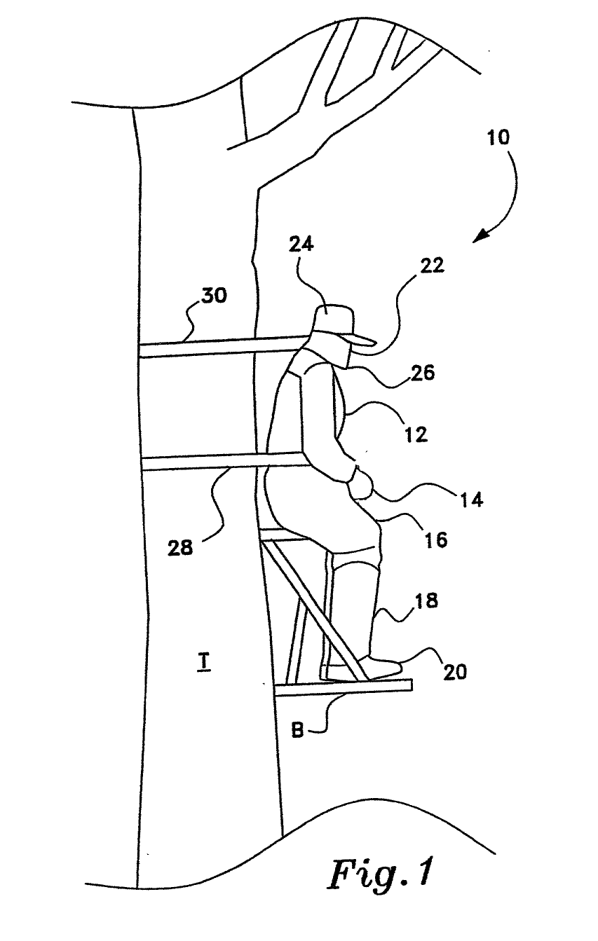

Referring to FIGS. 1-6, there is disclosed a stuffed human decoy 10 and methods 50 and 60 for making and using the stuffed human decoy 10. Basically, the stuffed human decoy 10 (e.g., dummy, mannequin) can be placed in a deer blind or tree stand to take the place of a hunter so that, when the hunter is absent, the presence of the human decoy 10 conditions wild animals to the presence of the hunter. The human decoy 10 also serves as a trespassing tool to deter another hunter from coming too close to the hunting area of the hunter.

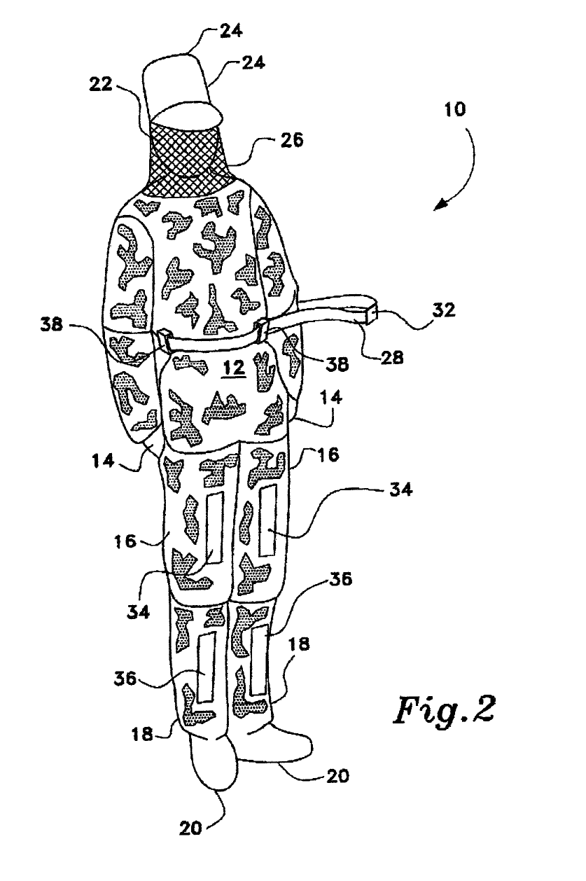

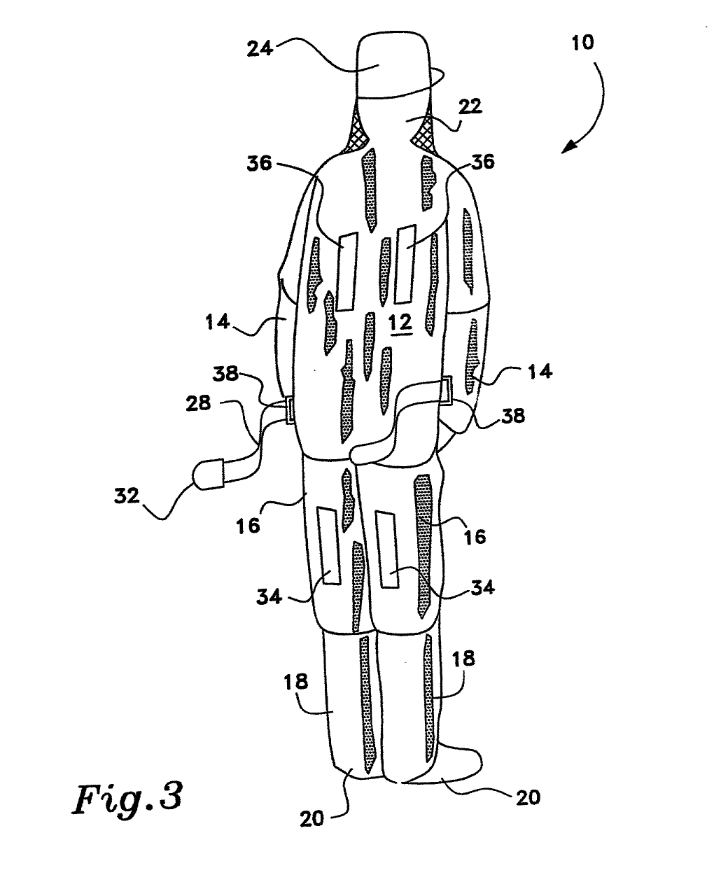

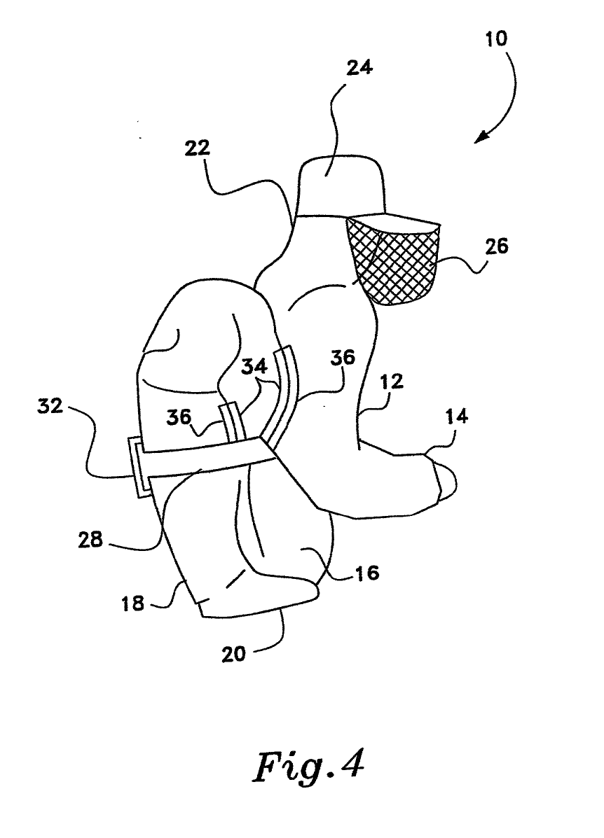

Referring to the FIGS. 1-4 there are shown an environmental perspective view, a front elevated view, a rear elevated view, and a folded side view, respectively, of the human decoy 10. As shown, the human decoy 10 includes a torso 12, arms 14, thighs 16, shins 18, feet 20 and a head 22. The human decoy 10 is also shown wearing a hat 24 with netting 26 that can extend around the hat 24 or can extend from the bill of the hat 24 (see FIG. 4). The human decoy 10 includes a waist strap 28 and possibly a neck strap 30 one of which or both can hold the human decoy 10 in either a standing or sitting position to a tree trunk (T) near a deer blind or tree stand (see FIG. 1). The waist strap 28 may be fastened at the rear of the human decoy 10 by a clamp buckle 32. Two opposing waist loops 38 may be mounted on the torso 12 and used for supporting the waist strap 28. Mating hooks 34 and loop patches 36 such as Velcro are utilized to fold the human decoy 10 for transport (see FIG. 4). The waist strap 28 and clamp buckle 32 can also be used to help keep the human decoy 10 in the folded position (see FIG. 4). The human decoy 10 is preferably dressed in camouflage for fall (see FIG. 2) or winter (see FIG. 3) use, or may also be a solid color. The camouflage can include patterns such as Mossy Oak® Break Up, Realtree®, Advantage Timber®. Essentially, the human decoy 10 may be made of any desired fabric (e.g., weather proof durable cloth) and filled with any desired stuffing (e.g., recycled plastic, cloth).

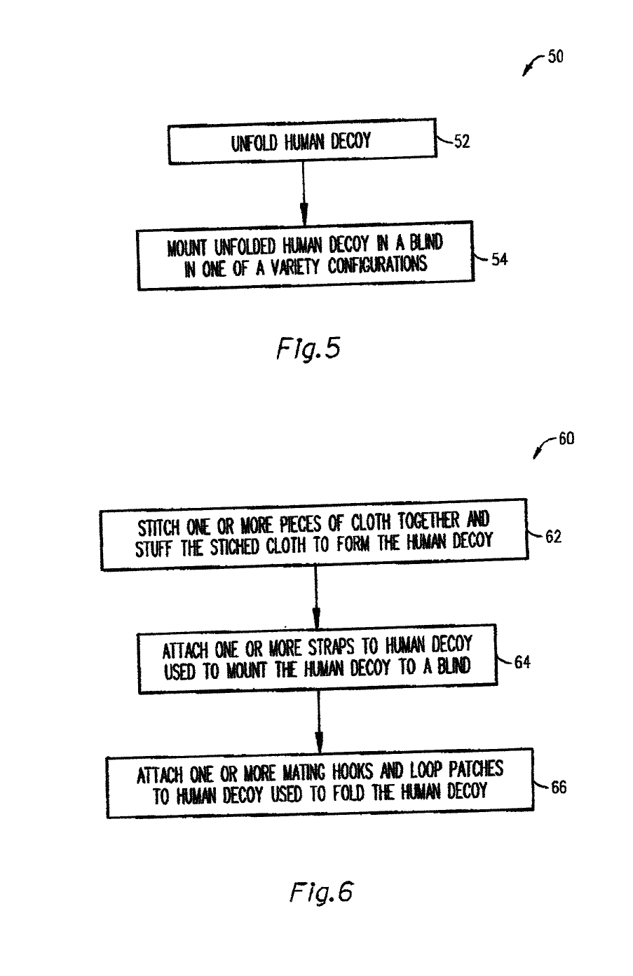

Referring to FIG. 5, there is a flowchart illustrating the steps of a preferred method 50 for using the human decoy 10. Prior to the hunting season, the human decoy 10 is unfolded (step 52) from the folded position (see FIG. 4) and then mounted (step 54) to in a blind (B) using the waist strap 28 and/or the neck strap 30. The hunter can mount the human decoy 10 to the blind (B) in a variety of positions including, for example, a sitting position (see FIG. 1) or a standing position (see FIG. 3). The presence of the human decoy 10 in the blind (B) or the tree stand operates to condition the game (e.g., deer) to the presence of a hunter. The human decoy 10 can also be placed in a ground blind (not shown). Typically, the human decoy 10 would be positioned in the same manner as the hunter would seat himself/herself in the blind (B).

When hunting season opens, the hunter removes the human decoy 10 and positions himself/herself in its place. After removing the human decoy 10 from the blind (B), the hunter would usually fold the human decoy 10 by folding the shins 18 upon the thighs 16 and then folding the thighs 16 onto the back of the torso 10 (see FIG. 4). The folds are primarily held by mating hooks 34 and loop material patches 36. However, the folds can be further secured and tightened by the waist strap 28.

Referring to FIG. 6, there is a flowchart illustrating the steps of a preferred method 60 for making the human decoy 10. First, the manufacturer would stitch or sew (step 62) one or more pieces of cloth together and then stuff the sewed cloth with stuffing (e.g., filler material) to form the human decoy 10. The human decoy 10 can be made of any desired fabric (e.g., weather proof durable cloth) and filled with any desired stuffing (e.g., recycled plastic, cloth). Moreover, the human decoy 10 can be dressed in camouflage clothing for fall (see FIG. 2) or winter (see FIG. 3) use, or may also be a solid color. Alternatively, the cloth used to make the human decoy 10 may be camouflaged such that the human decoy 10 does not need to have clothing. The camouflage can include patterns such as Mossy Oak® Break Up, Realtree®, Advantage Timber®.

The manufacturer then attaches (step 64) one or more straps 28 and 30 to the human decoy 10 which can be used by the hunter to mount the human decoy 10 to a blind or to stabilize a folded human decoy 10. As shown in FIG. 1, the human decoy 10 includes the waist strap 28 and neck strap 30 one of which or both can hold the human decoy 10 in either a standing or sitting position to a tree trunk (T) near a deer blind or tree stand. The waist strap 28 may be fastened at the rear of the human decoy 10 by a clamp buckle 32. Two opposing waist loops 38 may be mounted on torso 28 for supporting the waist strap 28.

Finally, the manufacturer attaches (step 66) one or more mating hooks 34 and loop patches 36 to various locations on the human decoy 10 which enable the hunter to fold the human decoy 10. As shown, the mating hooks 34 are attached to the back of the thighs 16 and the front of the shins 18. The loop material patches 36 are attached to the back of the torso 12 and front of the thighs 16. Alternatively, the mating hooks 34 and the loop material latches 36 can be attached to a wide variety of locations on the human decoy 10 so long as the hunter can fold the human decoy 10.

From the foregoing, it can be readily appreciated by those skilled in the art that the present invention provides a stuffed human decoy and methods for making and using the human decoy. As disclosed, the human decoy (e.g., dummy, mannequin) can be placed in a deer blind or tree stand to take the place of a hunter so that, when the hunter is absent, the presence of the human decoy conditions wild animals to the presence of the hunter. The human decoy also serves as a trespassing tool to deter another hunter from coming too close to the hunting area of the hunter.

Although only one embodiment of the present invention have been illustrated in the accompanying Drawings and described in the foregoing Detailed Description, it should be understood that the invention is not limited to the embodiment disclosed, but is capable of numerous rearrangements, modifications and substitutions without departing from the spirit of the invention as set forth and defined by the following claims.

What is claimed is:

1. A stuffed human decoy, comprising:
a head; and
a torso, attached to said head, bearing a pair of arms and bearing a pair of legs including thigh portions, shin portions and feet, wherein said stuffed human decoy is capable of being placed in a plurality of positions from standing to sitting and further capable of being placed in a blind to condition game.

2. The stuffed human decoy of claim 1, further comprising at least one strap capable of holding said stuffed human decoy to the blind.

3. The stuffed human decoy of claim 2, wherein said at least one strap includes a waist strap and a neck strap.

4. The stuffed human decoy of claim 1, further comprising a waist strap that is supported on said torso by opposing side loops and includes a clamp buckle for securing said stuffed human decoy to a tree trunk.

5. The stuffed human decoy of claim 1, wherein said stuffed human decoy is capable of being placed in a folded position.

6. The stuffed human decoy of claim 1, wherein said stuffed human decoy is capable of being placed in a folded position by folding the shin portions upon the thigh portions and folding the thigh portions upon a back of said torso.

7. The stuffed human decoy of claim 6, further comprising at least one strap capable of being wrapped around the torso, the folded shin portions and the folded thigh portions to help keep the stuffed human decoy in the folded position.

8. The stuffed human decoy of claim 6, further comprising at least one mating hook and at least one loop patch attached to various locations on the stuffed human decoy to help keep the stuffed human decoy in the folded position.

9. The stuffed human decoy of claim 1, further comprising a cap, located on said head, including a bill and a netting connected to the bill.

10. The stuffed human decoy of claim 1, wherein said stuffed human decoy is camouflaged.

11. A method for using a stuffed human decoy, said method comprising the steps of:
unfolding the stuffed human decoy, said stuffed human decoy includes:
a head; and
a torso, attached to said head, bearing a pair of arms and bearing a pair of legs including thigh portions, shin portions and feet, wherein said stuffed human decoy can be placed in a to folded position by folding the shin portions upon the thigh portions and folding the thigh portions upon a back of said torso; and
mounting said unfolded stuffed human decoy in a blind to condition game.

12. The method of claim 11, wherein said stuffed human decoy further includes at least one strap capable of holding said stuffed human decoy to the blind.

13. The method of claim 11, wherein said stuffed human decoy further includes a waist strap that is supported on said torso by opposing side loops and includes a clamp buckle for securing said stuffed human decoy to a blind.

14. The method of claim 11, wherein said stuffed human decoy further includes a cap, located on said head, including a bill and a netting connected to the bill.

15. The method of claim 11, wherein said stuffed human decoy is camouflaged.

16. A method for making a human decoy, said method comprising the steps of:
sewing together at least one piece of cloth and stuffing the sewed cloth with a filler material to form the human decoy, said human decoy including:
a head; and
a torso, attached to said head, bearing a pair of arms and bearing a pair of legs including thigh portions, shin portions and feet, wherein said stuffed human decoy is capable of being placed in a plurality of positions from standing to sitting; and
attaching at least one strap to the human decoy which can be used to mount said human decoy in a blind to condition game.

17. The method of claim 16, further comprising a step of attaching at least one mating hook and at least one loop patch to various locations on the stuffed human decoy which when connected to one another enable the human decoy to be placed in a folded position.

18. The method of claim 16, wherein said human decoy further includes a cap, located on said head, including a bill and a netting connected to the bill.

19. The method of claim 16, wherein said human decoy is camouflaged.

20. The method of claim 16, wherein said filler material is plastic stuffing.
